(19) United States
(12) Patent Application Publication
(10) Pub. No.: US 2021/0182770 A1
(43) Pub. Date: Jun. 17, 2021

(54) SYSTEMS AND METHODS FOR AUTOMATED DELIVERY WORKER SCHEDULING

(71) Applicant: COUPANG CORP., Seoul (KR)

(72) Inventors: Dae Jin MOON, Seoul (KR); Soo Young YANG, Seoul (KR); Seok Hun LIM, Seoul (KR)

(73) Assignee: COUPANG, CORP.

(21) Appl. No.: 16/714,272

(22) Filed: Dec. 13, 2019

(51) Int. Cl. G06Q 10/08; G06Q 10/10

(52) U.S. Cl. CPC G06Q 10/083; G06Q 10/1093

(57) ABSTRACT

A system for automated delivery worker scheduling. The system may include a memory storing instructions and at least processor configured to execute the instructions to perform operations. The operations may include receiving a forecasted number of sold units for a first period of time; receiving a unit per parcel rate associated with a plurality of camps; determining a number of parcels for the plurality of camps based on the forecasted number of sold units and the respective unit per parcel rate; determining forecasted attendance information for the plurality of camps; determining a number of delivery workers based on the forecasted attendance information and the number of parcels; and assigning a plurality of the parcels to the determined delivery workers.

### TECHNICAL FIELD

The present disclosure generally relates to computerized systems and methods for automated delivery worker scheduling. In particular, embodiments of the present disclosure relate to inventive and unconventional systems for forecasting a number of sold units, determining a number of parcels required for delivery of the sold units, and automatically determining an optimum delivery worker schedule for delivery of the determined number of parcels.

### BACKGROUND

Numerous computerized inventory management systems and delivery centers exist. These systems and centers are designed to enable efficient distribution of goods in an established delivery area and to utilize available resources for delivering these goods to consumers, for example, at local shipping centers. Traditionally, each delivery center may divide its established delivery area into separate regions, and then these systems may direct delivery workers to deliver the goods to one or more of the regions.

Typically, however, each region is only covered by a single delivery worker, who may be unable to keep up with a region's delivery demands. Further, conventional systems are unable to dynamically adjust regional assignment of delivery workers. Moreover, conventional systems are often not able to flexibly cope with a dynamic or changing delivery or sales forecast. Nor are they equipped to analyze a delivery vehicle's load limit or consider a delivery worker's delivery efficiency or skill.

Even further, numerous computerized inventory management systems include one or more administrators in charge of manually assigning delivery workers to deliver packages, which may add to an increase in delivery time and may result in delivery inefficiencies. Such administrator-based systems often times fail to accurately account for the required number of packages or parcels that need to be delivered.

Therefore, what is needed is a system that is capable of dynamically determining an optimum delivery worker schedule for timely and accurate delivery of a required number of parcels. Further, what is needed is a digital delivery solution that can quickly and flexibly handle unpredictable changes based on changes in sale forecasts and available delivery men resources. Finally, what is needed are improved methods and systems for facilitating reassignment of delivery workers from one area to another in order to accommodate geographic and cyclical changes in sales forecasts.

### SUMMARY

One aspect of the present disclosure is directed to a system for automated delivery worker scheduling. The system may include at least one processor; and at least one non-transitory storage medium comprising instructions that, when executed by the at least one processor, cause the at least one processor to perform steps. The steps may include receiving a forecasted number of sold units for a first period of time; receiving a unit per parcel rate associated with a plurality of camps; determining a number of parcels for the plurality of camps based on the forecasted number of sold units and the respective unit per parcel rate; determining forecasted attendance information for the plurality of camps; determining a number of delivery workers based on the forecasted attendance information and the number of parcels; and assigning a plurality of the parcels to the determined delivery workers.

Another aspect of the present disclosure is directed to a method for automated delivery worker scheduling. The method may include receiving a forecasted number of sold units for a first period of time; receiving a unit per parcel rate associated with a plurality of camps; determining a number of parcels for the plurality of camps based on the forecasted number of sold units and the respective unit per parcel rate; determining forecasted attendance information for the plurality of camps; determining a number of delivery workers based on the forecasted attendance information and the number of parcels; and assigning a plurality of the parcels to the determined delivery workers.

Yet another aspect of the present disclosure is directed to a system. The system may include a memory storing instructions; and at least one processor configured to execute the instructions to perform operations. The operations may include receiving a forecasted number of sold units for a first period of time; receiving a unit per parcel rate associated with a plurality of camps; determining a number of parcels for the plurality of camps based on the forecasted number of sold units and the respective unit per parcel rate; determining forecasted attendance information for the plurality of camps; determining a number of delivery workers based on the forecasted attendance information and the number of parcels; determining the number of delivery workers is insufficient for delivery of the number of parcels to at least a first camp; reassigning a fixed number of delivery workers from a second camp to the first camp; assigning, based on the reassignment, flex delivery workers to the first camp; and assigning a plurality of the parcels to the reassigned and flex delivery workers.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIGS. 3-5 depict diagrammatic illustrations of an exemplary automated delivery worker schedule and timeline, consistent with the disclosed embodiments.

FIG. 6 depicts a diagrammatic illustration of the overall performance of an entire forecast calculation, consistent with the disclosed embodiments.

FIG. 7 is a flow chart illustrating an exemplary process for automating delivery worker scheduling, consistent with the disclosed embodiments.

FIGS. 8-10 are flow charts illustrating exemplary processes for a scheduling algorithm, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for automating delivery worker scheduling including automatically determining an optimum delivery worker schedule for delivery of a required number of parcels in a particular delivery area.

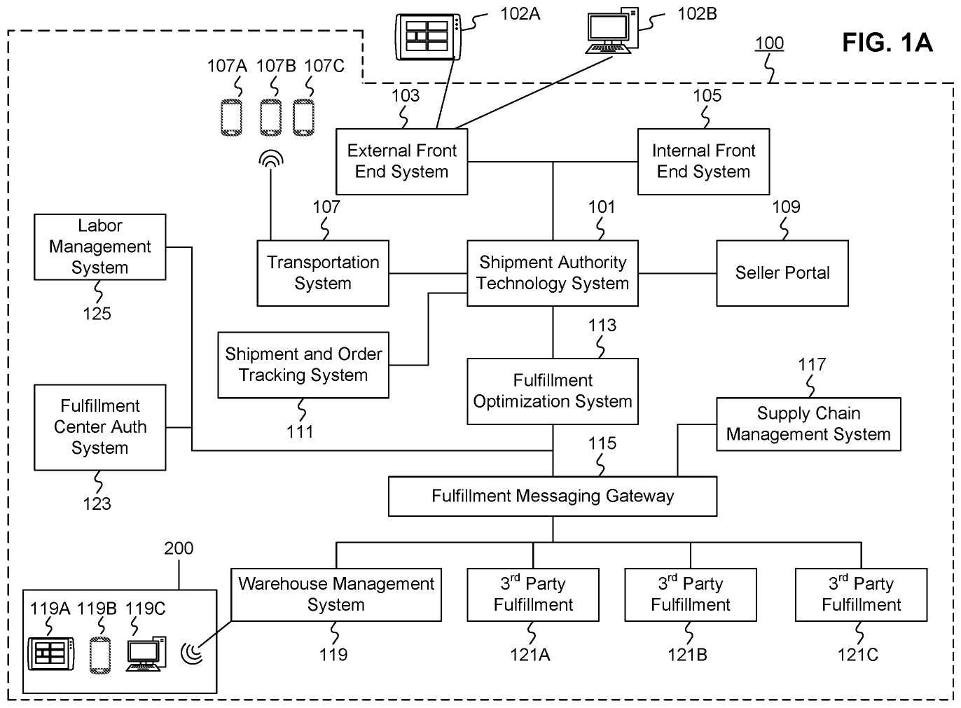

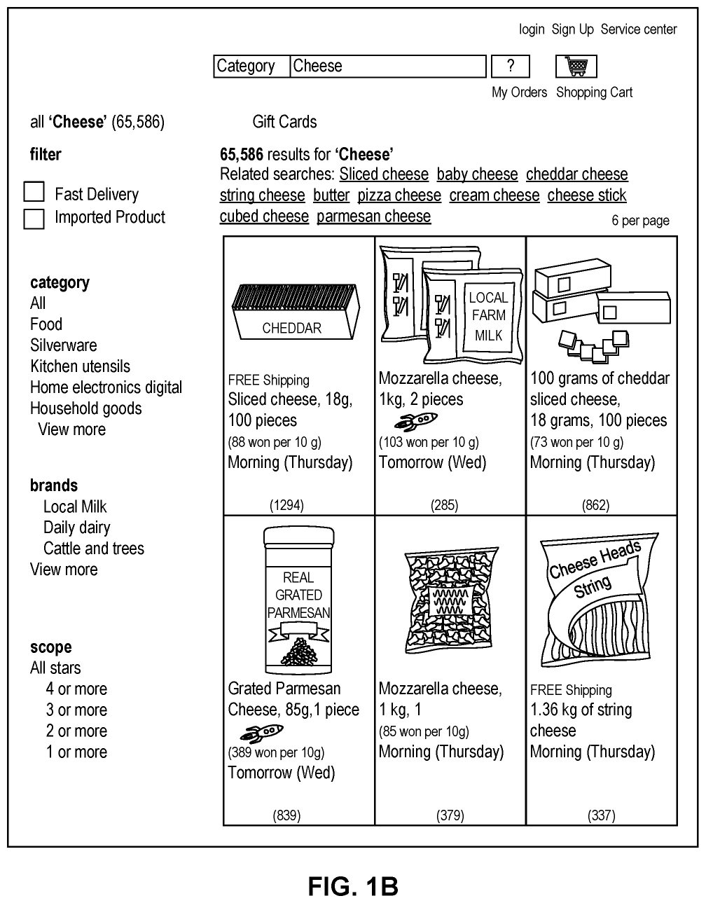

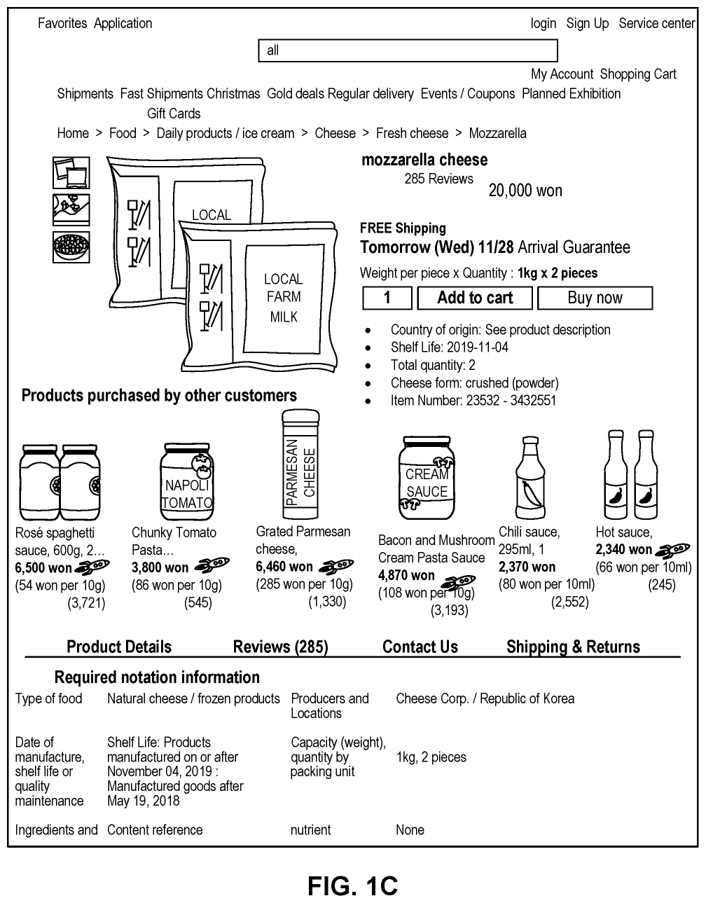

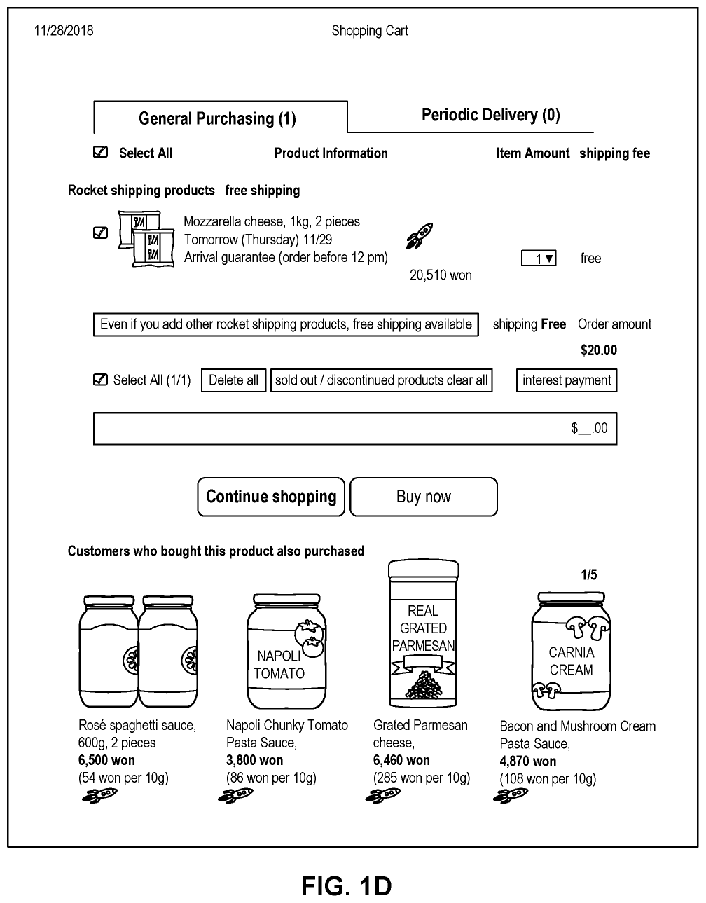

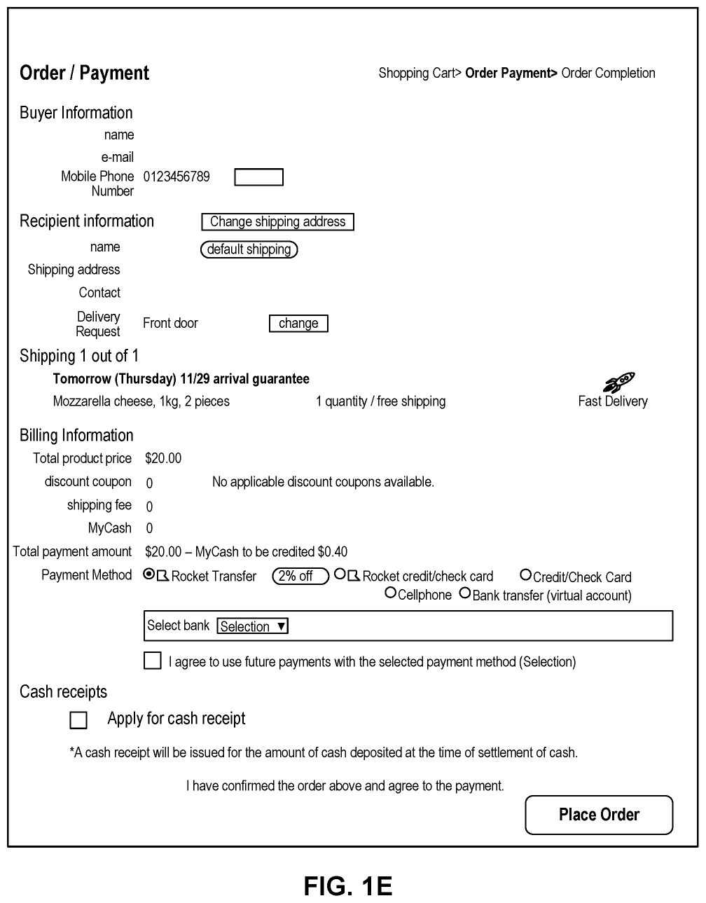

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

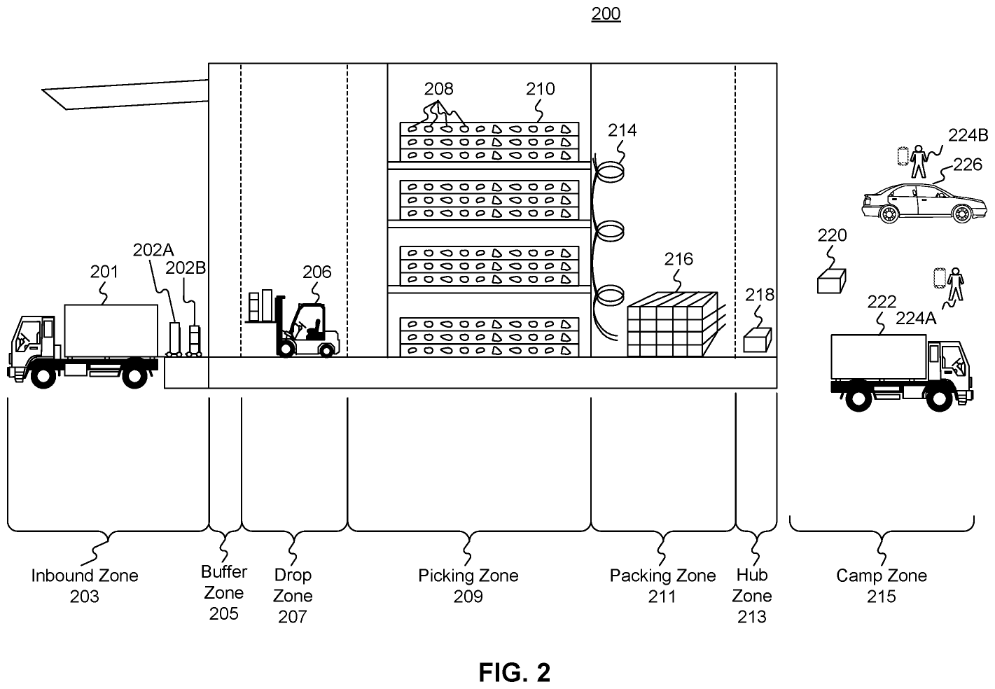

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

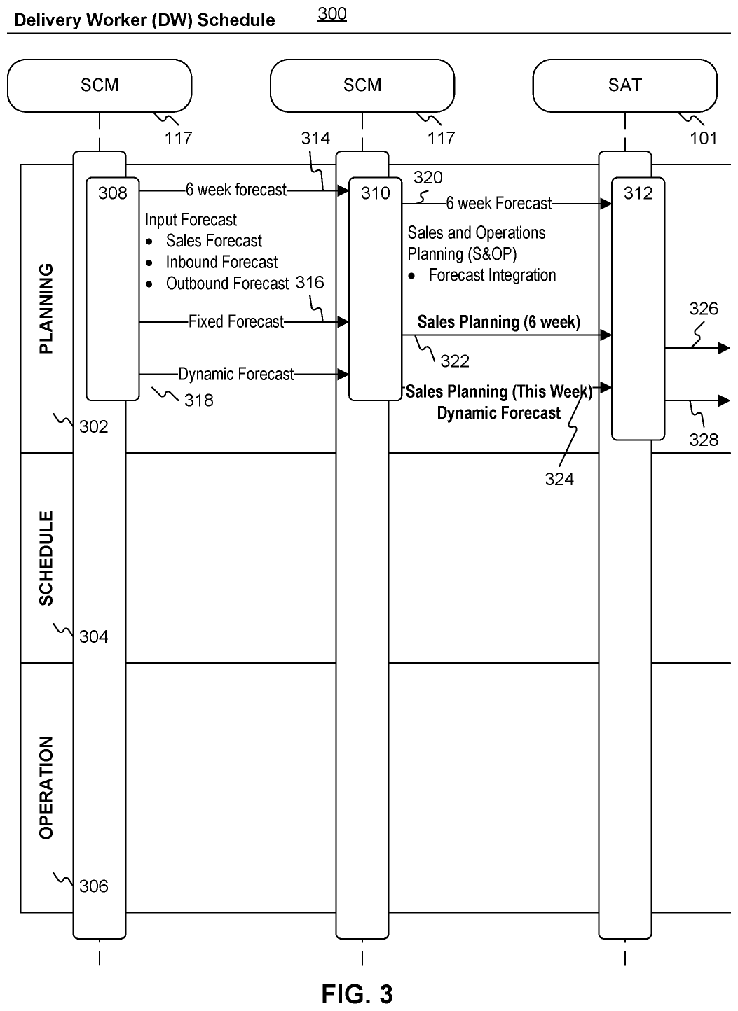

FIGS. 3-5 depict diagrammatic illustrations of an exemplary automated delivery worker (DW) process 300, consistent with the disclosed embodiments. As shown in FIG. 3, delivery worker process 300 may be shown in matrix form and may be divided into different stages or phases. Delivery worker (DW) process 300 may include a planning phase 302, a schedule phase 304, and an operation phase 306. As shown in FIG. 3, planning phase 302 may include planning for a forecast 308 based on a forecast calculation.

Shipment authority technology system (SAT) 101, transportation system 107, supply chain management system (SCM) 117, and/or labor management system (LMS) may generate, based on a received actual number of units, a number of parcels received, and a unit per parcel rate, a forecast calculation for forecast 308. The forecast calculation may include a first multiplication of a number of parcels received, by the unit per parcel rate to determine a forecast for an anticipated number of units that may be delivered relative to available parcels during a particular time period. The result of the first multiplication may then be compared to the received number of units sold to determine forecast 308.

For example, in an exemplary embodiment, 500 units may be sold and a unit per parcel rate of 5 stock keeping units (SKUs)/1 parcel may be received. Unit per parcel rate may reflect how many items are included in each package (on average). These values may subsequently be multiplied by each other resulting in 100 parcels required for delivery. Subsequently, in other embodiments, systems 101, 107, 117, and 125 may next compare a calculated or forecasted number of parcels (e.g. 100 parcels) to a received indication of a number of parcels received during an initial time period for a camp. Where the calculated or forecasted number of parcels (e.g. 100 parcels)exceeds the result of the indication of a number of parcels received during an initial time period for a camp, systems 101, 107, 117, and 125 may only deliver the number of parcels received during the initial time period for a camp (e.g. since less than 100 parcels are available for delivery). Alternatively, where the calculated or forecasted number of parcels (e.g. 100 parcels) is determined as less than the result of the indication of a number of parcels received during an initial time period for a camp, systems 101, 107, 117, and 125 may deliver the full calculated or forecasted number of parcels (e.g. 100 parcels) for the camp (e.g. since more than the required 100 parcels are available for delivery) s). Other forecast calculation methodologies comparing a received actual number of units, number of parcels received, and unit per parcel rate, may be contemplated

Consistent with this disclosure, a forecast calculation may be further based on the camp-level capacity. Camp-level capacity may reflect an upper threshold number of units that may be sold and delivered to a camp during an identified time period. Similarly, a camp may be associated with a camp-level capacity. Further, a camp may be associated with a first set of postal codes, and an actual number of units sold may comprise a number of units associated with a plurality of camps. While a forecast of a number of parcels may be generated based on three factors: units sold, units per parcel (e.g. how many boxes will be needed), and camp coverage (how many boxes arrived at a camp), additional factors may be included in a forecast calculation. For example, each camp team may further input a forecast value at a graphical user interface (GUI), and any of systems 101, 107, 117, and 122 may receive volume related information. Other forecast calculation methodologies may be contemplated in order to generate delivery worker (DW) process 300 and forecast 308 as shown in FIG. 3.

As further shown in FIG. 3, planning phase 302 of delivery worker (DW) process 300 may include planning for forecast 308, forwarding forecast 308 at time 310, and forwarding forecast 308 at time 312. As shown in FIG. 3, delivery worker process 300 may be based on a weekly calculation of delivery worker schedules. However, other embodiments based on other time periods are possible as well. Forecast 308 may constitute an exemplary 6-week forecast 314. Exemplary 6-week forecast 314 may begin on a Tuesday, but other starting days during the week may be contemplated. Forecast 308 may also include an input forecast which may include a sales forecast, an inbound forecast, and an outbound forecast. Forecast 308 may also be a fixed forecast 316 or a dynamic forecast 318. A fixed forecast may remain static and a dynamic forecast may be changed based on input values, such as a preferred starting day or a preference in forecast duration.

In some embodiments, as shown in FIG. 3, SCM 117 may forward the forecast 308 at time 310. SCM 117 may incorporate sales and operation planning (S&OP) data at step 320 and include forecast integration data to SAT 101 at time 312. At step 322, SCM 117 may also forward other sales planning data 322 relating to fixed forecast 316 as well as other sales planning data 324 relating to dynamic forecast 318 at time 312. At time 312, SAT 101 may calculate an estimate 326 of camp parcels for fixed forecast 316 and may also calculate an estimate 328 of camp parcels for dynamic forecast 318. Estimate 326 may include a number of camp parcels estimated on Wednesday and Friday. Estimate 328 may also include a number of camp parcels estimated 334 on Monday and Wednesday. Other estimated days may be used for forecasting. S&OP planning information and manufacturing information including unit per parcel (for example, for an exemplary time period of 2 weeks) and camp coverage information (relating to each camp forecast, fixed and dynamic) may be contemplated.

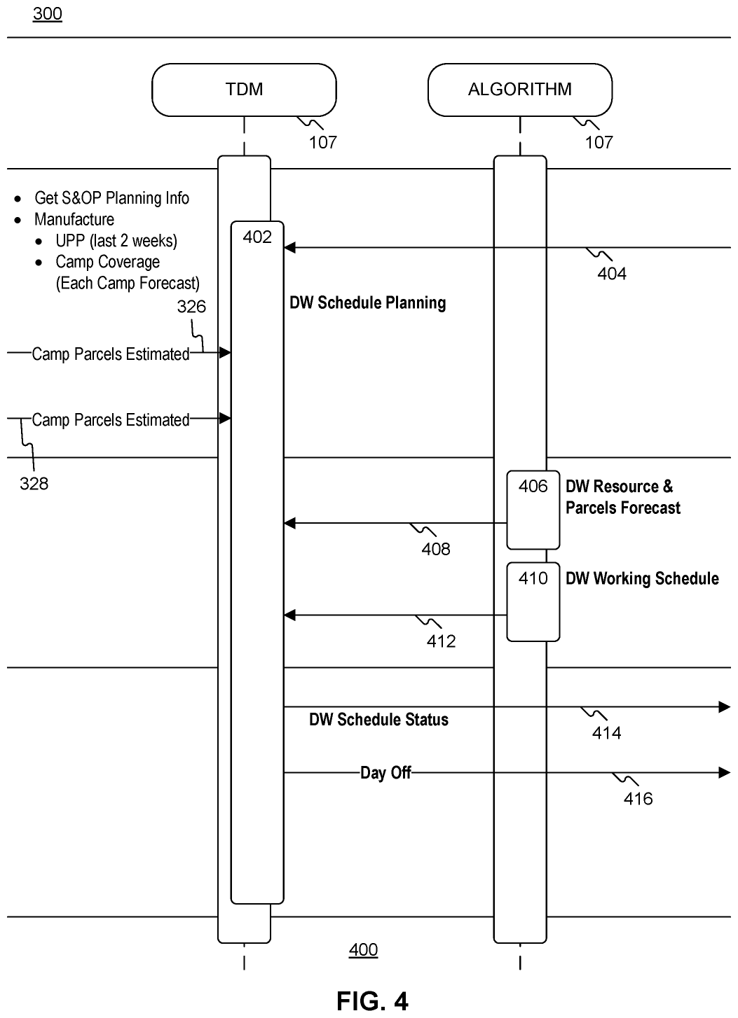

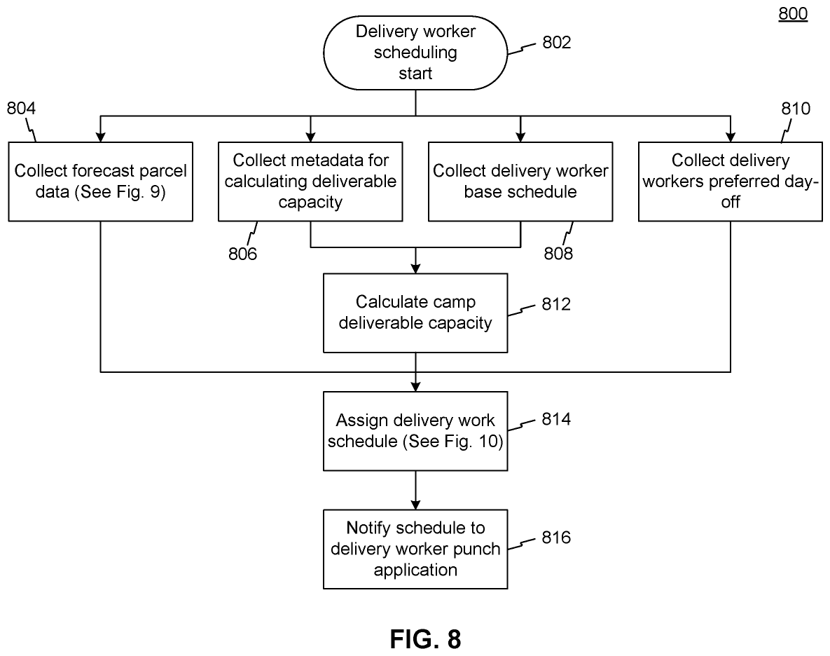

As shown in FIG. 4, delivery worker (DW) process 300 may further include transportation system (TDM) 107 for executing an algorithm to perform forecasting and scheduling operations. TDM 107 may receive information from SCM 117 and SAT 101 and may perform an algorithm to further refine forecast calculation for forecast 308. At time 402, TDM 107 may include DW schedule planning based on an input from one or more delivery workers. An algorithm (as further discussed below with reference to FIGS. 8-10) may also conduct a DW Resource and parcels forecast 406 as part of scheduling 304 and may also determine a DW working schedule 410, both of which may be provided as inputs 408 and 412 to TDM 107 for enhancing scheduling 304. As shown in FIG. 4, TDM 107 may also provide as an input schedule status 414 and insert values relating to delivery worker days off 416.

In some embodiments, an algorithm may be optimal handling of a specific volume arrival pattern for camps, where the volume may be highest on Tuesdays and Wednesdays, while being lowest on Saturdays and Sundays. In some scenarios, a volume may be highest at the start of the month. In other scenarios, there may also be unfair delivery worker day off scheduling, where day offs may be scheduled manually at the individual or group level. Weekend days may be typically preferred by most delivery workers and day offs may be assigned based on priority. Therefore, an algorithm (as discussed with reference to FIGS. 8-10 below) may be used. Furthermore, promised Delivery Date (PDD) misses may also be caused by delivery capacity shortage, and PDD misses may be caused on days where the volume spikes when there are not enough delivery resources available. A waste of unused delivery workers or deliver resources may also be generated on days with low volumes. Accordingly, in view of the changes in volume, an algorithm may be used to assign delivery work days off in line with a volume forecast and/or to calculate a delivery capacity based on a delivery worker count scheduled to work in order to help respond to potential issues ahead of time (as further discussed with reference to FIGS. 8-10).

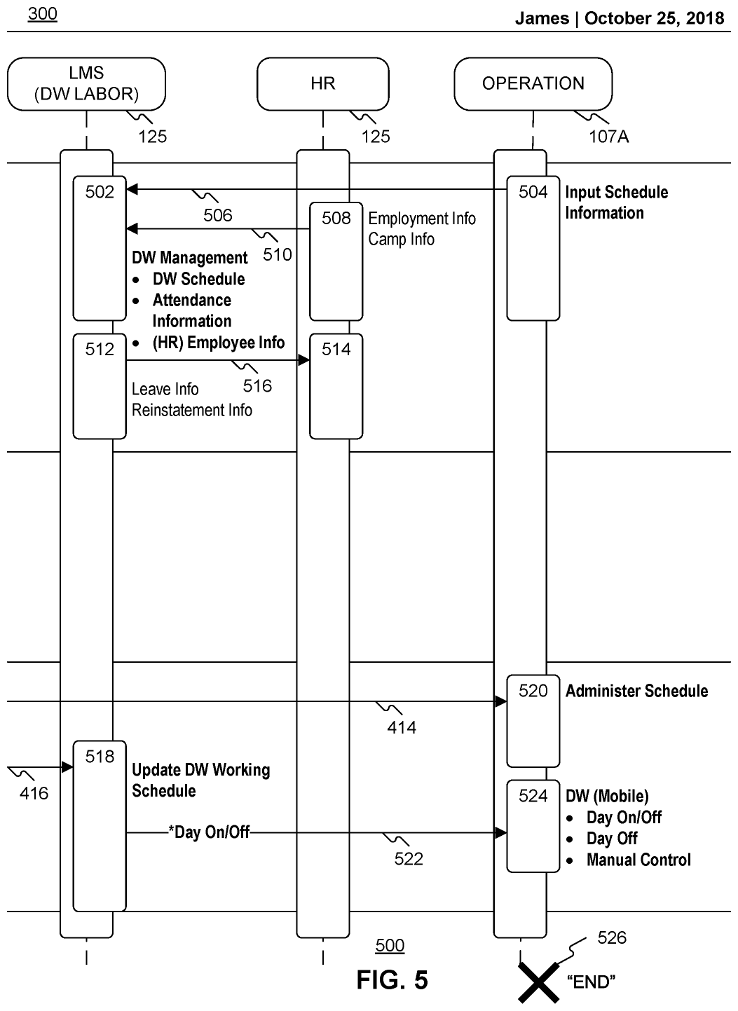

As shown in FIG. 5, LMS 125, HR (a Human Resources process, also performed by LMS 125), and an operation (performed by device 107A) may perform further processes. At time 502, operation 107A may input schedule information at subsystem 502 where a user could use a device (e.g., 107A) to input a desired work schedule, including holidays. At subsystem 508, employment information and camp information may send at step 510. DW Management information including DW schedule information, attendance management information, and HR employee information may also be inputted by LMS 125. Attendance management information may include a delivery worker's schedule, clock-in and clock-out time information, and employee information (e.g., name, phone number, employee records). At subsystem 512, leave information and reinstatement information may also be sent at time 516 to HR subsystem 514. At subsystem 518, LMS 125 may perform updating a DW working schedule. To update, LMS 125 may force a periodic “push” or “pull” responsive to update(s) made at 518, and/or any other known means of communication or synchronization. LMS 125 may also act as a data source that operation (107A) may periodically receive data from. In other embodiments, LMS 125 may send a day on/off 522 command to subsystem 524 which may update the DW working schedule. In other embodiments, subsystem 524 may further provide a DW mobile application which may allow for manual control for updating a DW working schedule and which may allow for a manual input update of delivery worker off days (according to day on/off command 522). At subsystem 520, operation performed by device 107A may further provide a DW working schedule update for administering a schedule. Other steps and operations now shown for updating a DW working schedule may be contemplated consistent with this disclosure.

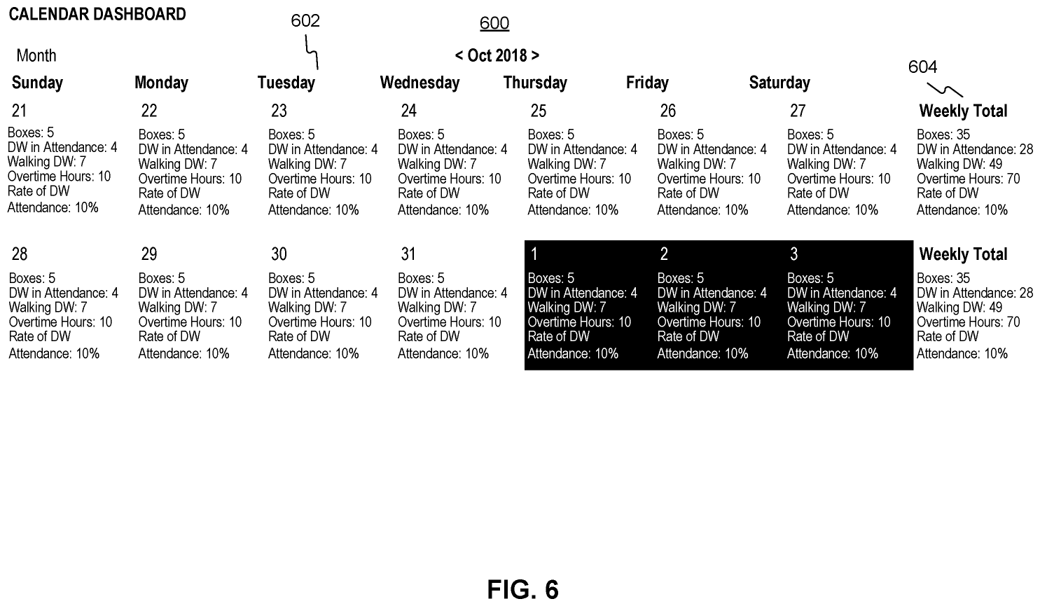

FIG. 6 depicts a diagrammatic illustration of the overall performance of the entire forecast calculation 600, consistent with the disclosed embodiments. As shown in FIG. 6, an exemplary calendar for the month of October 2018 is displayed and shows the overall performance of the entire forecast calculation 600. On a daily basis 602, numerous metrics are tabulated. These metrics include a number of boxes (i.e. how many parcels went through the forecast calculation on that day), a number of delivery workers (DW) in attendance, a number of walking delivery workers (DW) in attendance, a number of overtime workers (i.e. a number of hours that were worked overtime in the forecast calculation) and a rate of delivery worker (DW) attendance. Walking delivery workers may include only delivery workers that walk to make deliveries as opposed to driving delivery workers that drive to a location to make a delivery. Often times, walking delivery workers may be paired with driving delivery workers for a particular delivery.

As shown in FIG. 6, these metrics may vary on a daily basis or may stay the same over time. Weekly Total 604 aggregates may be calculated for the week. Other metrics and statistics may be calculated and displayed on a calendar.

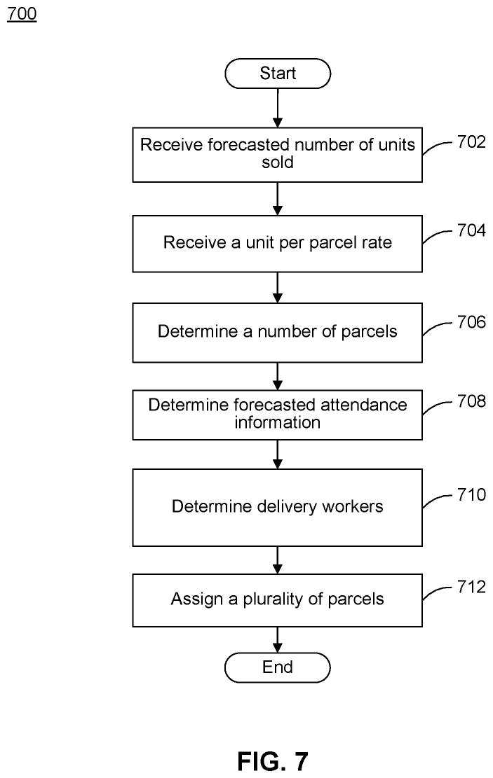

FIG. 7 is a flow chart illustrating an exemplary process for automating delivery worker scheduling, consistent with the disclosed embodiments. While the exemplary method 700 is described herein as a series of steps, it is to be understood that the order of the steps may vary in other implementations. In particular, steps may be performed in any order, or in parallel. Moreover, while shipment authority technology system (SAT) 101, transportation system 107, supply chain management system (SCM) 117, and/or labor management system (LMS) 125 may perform the following steps, it is to be understood that systems 101, 107, 117, and 125 may operate separately or may work together collectively in any manner to perform the following steps.

At step 702, shipment authority technology system (SAT) 101, transportation system 107, supply chain management system (SCM) 117, and/or labor management system (LMS) 125 may receive a forecasted number of sold units for a first period of time. Shipment authority technology system (SAT) 101, transportation system 107, supply chain management system (SCM) 117, and/or labor management system (LMS) 125 may include determining forecasted attendance information for a set of delivery workers and may assign the plurality of the parcels to the determined delivery workers. This may include assigning the plurality of parcels based on the determined historical attendance information. Historical attendance information may be stored in a database or in memory. In an exemplary embodiment, transportation system 107 may search a database or memory for attendance information and may compare attendance information between a plurality of delivery workers. Transportation system 107 may also compare attendance information against a predetermined threshold value. Where transportation system 107 determines the attendance of a particular worker fails to exceed a predetermined threshold, system 107 may not assign a plurality of the parcels to the delivery worker. However, where transportation system 107 determines the attendance of a particular worker exceeds a predetermined threshold, transportation system 107 may assign a plurality of the parcels to a delivery worker. Multiple predetermined threshold values may be contemplated for evaluating delivery worker attendance.

At step 704, shipment authority technology system (SAT) 101, transportation system 107, supply chain management system (SCM) 117, and/or labor management system (LMS) 125 may receive a unit per parcel rate associated with a plurality of camps. At of the plurality of camps may be associated with a camp-level capacity and a camp-level efficiency. A unit per parcel rate may be stored in any of shipment authority technology system (SAT) 101, transportation system 107, supply chain management system (SCM) 117, and/or labor management system (LMS) 125 and may further determined by dividing the received number of units sold by the received number of parcels. At step 706, any of systems 101, 107, 117, and 125 may determine a number of parcels for the plurality of camps based on a forecasted number of sold units and the respective unit per parcel rate. A number of parcels for the first camp may further based on the associated camp-level capacity and camp-level efficiency. Other methods for determining a number of parcels for a plurality of camps may be contemplated.

At step 708, shipment authority technology system (SAT) 101, transportation system 107, supply chain management system (SCM) 117, and/or labor management system (LMS) 125 may determine forecasted attendance information for a plurality of camps. Any of systems 101, 107, 117, and 125 may determine the forecasted attendance rate based on receiving, from a mobile device associated with at least one delivery worker, vacation or absence information for the first time period. This data may be compared against other attendance data where a delivery worker was not on vacation or absent.

At step 710, shipment authority technology system (SAT) 101, transportation system 107, supply chain management system (SCM) 117, and/or labor management system (LMS) 125 may determine a number of delivery workers based on the forecasted attendance information and the number of parcels. The determined delivery workers may include permanent delivery workers. The plurality of delivery workers may comprise delivery workers, walking delivery workers, and driving delivery workers.

At step 712, shipment authority technology system (SAT) 101, transportation system 107, supply chain management system (SCM) 117, and/or labor management system (LMS) 125 may assign a plurality of the parcels to delivery workers. The assigning may include assigning fewer than the plurality of parcels to the permanent delivery workers, determining a difference between the plurality of the parcels and the assigned plurality of parcels to determine a number of deliverable parcels, determining a number of temporary delivery workers, and assigning the deliverable parcels to the temporary delivery workers. Assigning a plurality of the delivery workers may further comprise assigning based on individual target efficiency values for each delivery worker. Further, assigning based on individual target efficiency values may include assigning to reduce overtime or comply with a rule.

FIGS. 8-10 are flow charts illustrating exemplary processes for a scheduling algorithm, consistent with the disclosed embodiments. While the exemplary methods 800, 900, and 1000 are described herein as a series of steps, it is to be understood that the order of the steps may vary in other implementations. In particular, in certain embodiments, steps may be performed in any order, or in parallel. Moreover, while shipment authority technology system (SAT) 101, transportation system 107, supply chain management system (SCM) 117, and/or labor management system (LMS) 125 may perform one or more of the steps depicted in FIGS. 8-10, it is to be understood that systems 101, 107, 117, and 125 may operate separately or may work together collectively in any manner to perform the following steps.

At step 802, shipment authority technology system (SAT) 101, transportation system 107, supply chain management system (SCM) 117, and/or labor management system (LMS) 125 may begin an algorithm process that starts scheduling for a delivery worker. As shown in FIG. 4, delivery worker (DW) process 300 may include transportation system (TDM) 107 executing an algorithm to perform forecasting and scheduling operations. TDM 107 may receive information from SCM 117 and SAT 101 and may perform the algorithm process that starts scheduling for a delivery worker to further refine forecast calculation for forecast 308. TDM 107 may perform DW schedule planning based on an input from one or more delivery workers.

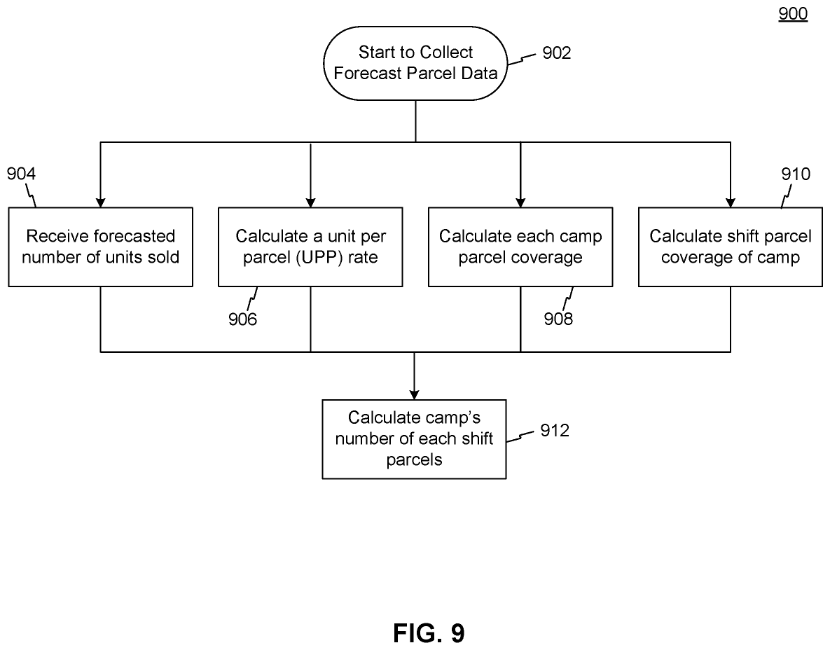

At step 804, shipment authority technology system (SAT) 101, transportation system 107, supply chain management system (SCM) 117, and/or labor management system (LMS) 125 may collect forecast parcel data (as shown in FIG. 9).

At step 902, systems 101, 107, or 125 may start to collect forecast parcel data, and at step 904, may receive a units sold forecast from SCM 117. The unit sold forecast may be calculated based on historical data and may be adjusted manually for products whose sales volume is projected to increase following a sales promotion. At step 906, in some embodiments, systems 101, 107, 117, and 125 may receive and calculate a unit per parcel (UPP). UPP may be calculated based on historical data and may be changed frequently as forecasts may changed once every 2-3 weeks. At step 908, in some embodiments, systems 101, 107, 117, and 125 may calculate each camp's parcel coverage based on a share of zipcodes covered by the camp. Coverage may be defined as the number of zipcodes assigned to each camp divided by the number of all zip codes in a certain geographical area. At step 910, in other embodiments, systems 101, 107, 117, and 125 may calculate each camp's parcel coverage by a shift or a time period of work. Shift-level parcel coverage may be defined by the percentage of volume covered by a shift (or working time period) at each camp. All camps may have their own shift (or working time period) schedule (e.g. 9 am to 5 pm). Shift-level parcel coverage may be calculated based on historical data. At step 912, in some embodiments, systems 101, 107, 117, and 125 may calculate an estimated parcel count according to a formula where a camp's shift parcels=forecasted number of units sold (904)/unit per parcel rate (906)*camp parcel coverage (908)*shift parcel coverage of camp (910); in other embodiments, the parcel count may be based on any of the foregoing values (units sold, UPP, a camp parcel coverage, coverage by shift, etc.).

At step 806, shipment authority technology system (SAT) 101, transportation system 107, supply chain management system (SCM) 117, and/or labor management system (LMS) 125 may collect metadata for delivery capacity calculation. In some embodiments, delivery capacity may refer to an amount of volume that can be delivered. In some embodiments, delivery capacity may equal a target parcel per day (PPD) multiplied by a personal weight. In some embodiments, target PPD may refer to a number of parcels that 1 delivery worker may aim to deliver in a day. In other embodiments, a target PPD may differ by day, camp, and camp shift. In some embodiments, a personal weight of 1.0 may apply if a delivery worker with more than 6 weeks experience makes deliveries the whole day. In other embodiments, different personal weights may be assigned to individuals depending on the number of weeks into the job. For example, new hires who have are 0-1 weeks experience onto the job may be assigned a weight of 0.0. Delivery work may not be assigned to new hires in their 1St week as the week is for new employee orientation including training sessions for delivery operations. In another example, new hires who are in weeks 1-2 may be assigned a weight of 0.5. However, on other embodiments, new hires in their second week may deliver only half of the target volume. In other embodiments, personal weights may vary based on work type. For example, weight assigned to delivery worker may be normalized at a value of 1.0. As another example, weight assigned to delivery workers delivering after sorting according to categories of morning, lifter, or sorter may be assigned at 0.5 weight. Weight assigned at delivery workers delivering to support another camp aside one's own may be assigned a value of 0.7 weight. Other weight value assignments may be used in some embodiments.

At step 808, shipment authority technology system (SAT) 101, transportation system 107, supply chain management system (SCM) 117, and/or labor management system (LMS) 125 may collect delivery worker base schedules. In some embodiments, base schedules pertain to annual leave, other leave types (maternity leave, alternative leave, reward vacation, official leave), and leave of absence (paid leave, unpaid leave, suspension). In some embodiments, delivery workers to whom off-days are to be assigned may be determined based on a base schedule that is collected and delivery capacity may be calculated according to the base schedules.

At step 810, shipment authority technology system (SAT) 101, transportation system 107, supply chain management system (SCM) 117, and/or labor management system (LMS) 125 may collect a delivery worker's preferred day off. In some embodiments, systems 101, 107, 117, and 125 may collect the preferred days off from the delivery workers. A preferred off-day is a value referred to when assigning days off to a delivery worker. The delivery worker's preference may be a factor in the algorithm but is not a requirement. In some embodiments, systems 101, 107, 117, or 125 may check whether delivery workers have been assigned off days on days of their preference in the most recent four weeks and may prioritize assigning off-days on preferred days for delivery workers who were least likely to be assigned a day off on the days of their preference.

At step 812, shipment authority technology system (SAT) 101, transportation system 107, supply chain management system (SCM) 117, and/or labor management system (LMS) 125 may calculate camp delivery capacity. In some embodiments, camp delivery capacity may equal the sum of each active delivery worker's delivery capacity. In some embodiments, active delivery workers may pertain to available manpower, specifically to those delivery workers who report to work at a camp and make deliveries. In some embodiments, systems 101, 107, 117, and 125 may calculate the delivery capacity by camp and by group within each camp and estimate any shortage or excess in delivery worker resources against a parcel count forecast.

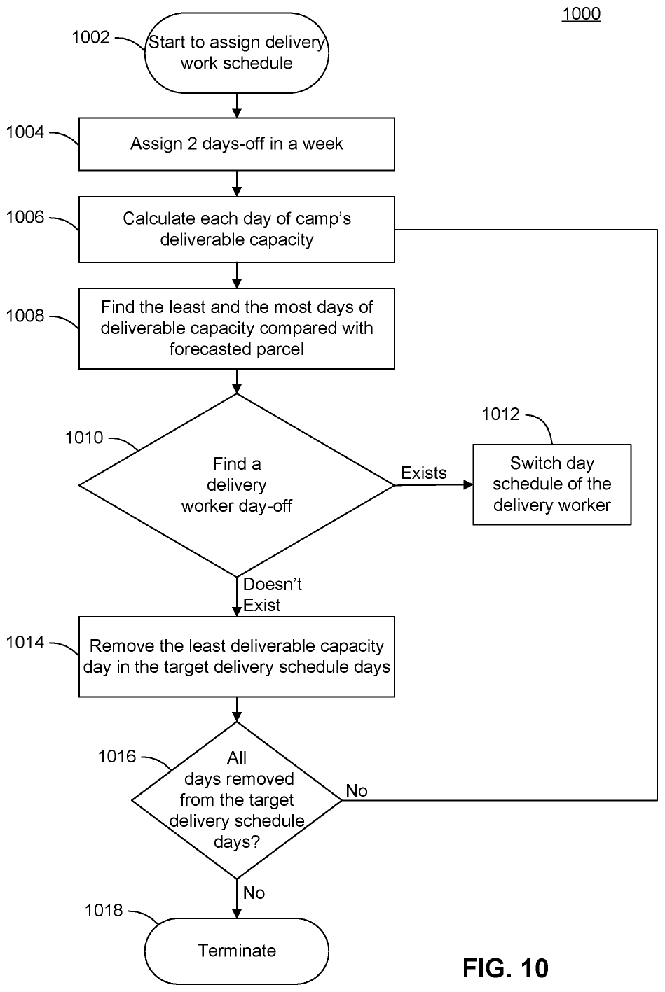

At step 814, shipment authority technology system (SAT) 101, transportation system 107, supply chain management system (SCM) 117, and/or labor management system (LMS) 125 may assign a delivery work schedule 1000. As shown in FIG. 10, at step 1002, systems 101, 107, 117, and 125 may start to assign a delivery work schedule. At step 1004, systems 101, 107, 117, and 125 may assign 2 days off per week. From the 2 days off, systems 101, 107, 117, and 125 may assign 1 day off to a preferred day and may assign the other day off randomly. In some embodiments, for delivery workers working 6 days a week, systems 101, 107, 117, and 125 may schedule a day off based on preference. At step 1006, in other embodiments, systems 101, 107, 117, and 125 may calculate a camp's delivery capacity for each day including for an assigned off day. At step 1008, in other embodiments, systems 101, 107, 117, and 125 may find the day with the lowest and highest delivery capacity against a forecasted parcel count. The days with the lowest and highest delivery capacities may be calculated by subtracting the delivery capacity from the parcel count forecast. At step 1010 other embodiments, systems 101, 107, 117, and 125 may find delivery workers who are off on the day when the delivery capacity is lowest while they are scheduled to work on the day when the delivery capacity is highest. This may be performed to find delivery workers who are off on days when there are not enough delivery workers and to have them report to work on those days. At step 1012, in some embodiments, systems 101, 107, 117, and 125 may switch the day off schedule of the delivery worker. This may include swapping the delivery worker schedule on the day with the lower delivery capacity with the schedule on the day with the highest delivery capacity. At step 1014, i other embodiments, systems 101, 107, 117, and 125 may remove the day with the lowest delivery capacity from the target days for delivery schedule assignment. At step 1016, in other embodiments, systems 101, 107, 117, and 125 may determine if all days are removed from the target days for delivery schedule assignment, and if so, may terminate at step 1018 the scheduling program performed by the processor.

At step 816, shipment authority technology system (SAT) 101, transportation system 107, supply chain management system (SCM) 117, and/or labor management system (LMS) 125 may notify a schedule to a delivery worker's punch application. The notification may take the form of an alert, email, or electronic message to communication to an application, consistent with this disclosure

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computerized system for automated delivery worker scheduling, comprising:
at least one processor; and
at least one non-transitory storage medium comprising instructions that, when executed by the at least one processor, cause the at least one processor to perform steps comprising:
receive a forecasted number of sold units for a first period of time;
receive a unit per parcel rate for each camp of a plurality of camps;
determine a number of parcels for the plurality of camps based on the forecasted number of sold units and the unit per parcel rate corresponding to a respective camp of the plurality of camps;
determine forecasted attendance information for the plurality of camps;
determining a number of delivery workers based on the forecasted attendance information and the number of parcels;
assigning a plurality of the parcels to the determined delivery workers; and
sending instructions to a mobile application to cause the mobile application to include the assignment.

2. The system of claim 1, wherein
determining forecasted attendance information comprises determining historical attendance information for a set of delivery workers; and
assigning the plurality of the parcels to the determined delivery workers comprises assigning the plurality of parcels based on the determined historical attendance information.

3. The system of claim 1, wherein determining the forecasted attendance information further comprises receiving, from a mobile device associated with at least one delivery worker, vacation or absence information for the first time period.

4. The system of claim 1, wherein the determined delivery workers comprise permanent delivery workers.

5. The system of claim 4, wherein assigning the plurality of the parcels to the determined delivery workers comprises:
assigning fewer than the plurality of parcels to the permanent delivery workers;
determining a difference between the plurality of the parcels and the assigned plurality of parcels to determine a number of deliverable parcels;
determining a number of temporary delivery workers;
assigning the deliverable parcels to the temporary delivery workers.

6. The system of claim 1, wherein at least one of the plurality of camps is associated with a camp-level capacity and a camp-level efficiency.

7. The system of claim 6, wherein the number of parcels for the at least one of the plurality of camps is further based on the associated camp-level capacity and camp-level efficiency.

8. The system of claim 1, wherein assigning a plurality of the delivery workers comprises assigning based on individual target efficiency values for each delivery worker.

9. The system of claim 8, wherein assigning based on individual target efficiency values comprises assigning to reduce overtime or comply with a rule.

10. The system of claim 1, wherein the determined delivery workers comprise driving delivery workers and walking delivery workers.

11. A computer-implemented method for automatic packaging determination, the method comprising:
receiving a forecasted number of sold units for a first period of time;
receiving a unit per parcel rate for each camp of a plurality of camps;
determining a number of parcels for the plurality of camps based on the forecasted number of sold units and the unit per parcel rate corresponding to a respective camp of the plurality of camps;
determining forecasted attendance information for the plurality of camps;
determining a number of delivery workers based on the forecasted attendance information and the number of parcels;
assigning a plurality of the parcels to the determined delivery workers; and
sending instructions to a mobile application to cause the mobile application to include the assignment.

12. The computer-implemented method of claim 11, the method further comprising:
determining forecasted attendance information comprises determining historical attendance information for a set of delivery workers; and
assigning the plurality of the parcels to the determined delivery workers comprises assigning the plurality of parcels based on the determined historical attendance information.

13. The computer-implemented method of claim 11, wherein determining the forecasted attendance information further comprises receiving, from a mobile device associated with at least one delivery worker, vacation or absence information for the first time period.

14. The computer-implemented method of claim 11, wherein the determined delivery workers comprise permanent delivery workers.

15. The computer-implemented method of claim 14, wherein assigning the plurality of the parcels to the determined delivery workers comprises:
assigning fewer than the plurality of parcels to the permanent delivery workers;
determining a difference between the plurality of the parcels and the assigned plurality of parcels to determine a number of deliverable parcels;
determining a number of temporary delivery workers;
assigning the deliverable parcels to the temporary delivery workers.

16. The computer-implemented method of claim 11, wherein at least one of the plurality of camps is associated with a camp-level capacity and a camp-level efficiency.

17. The computer-implemented method of claim 16, wherein the number of parcels for the at least one of the plurality of camps is further based on the associated camp-level capacity and camp-level efficiency.

18. The computer-implemented method of claim 11, wherein assigning a plurality of the delivery workers comprises assigning based on individual target efficiency values for each delivery worker.

19. A system comprising:
a memory storing instructions; and
at least one processor configured to execute the instructions to perform operations comprising:
receiving a forecasted number of sold units for a first period of time;
receiving a unit per parcel rate associated with a plurality of camps;
determining a number of parcels for the plurality of camps based on the forecasted number of sold units and the respective unit per parcel rate;
determining forecasted attendance information for the plurality of camps;
determining a number of delivery workers based on the forecasted attendance information and the number of parcels;
determining the number of delivery workers is insufficient for delivery of the number of parcels to at least a first camp;
reassigning a fixed number of delivery workers from a second camp to the first camp;
assigning, based on the reassignment, flex delivery workers to the first camp; and
assigning a plurality of the parcels to the reassigned and flex delivery workers.

20. The system of claim 19, wherein the flex workers do not work a fixed work schedule.
